(19) United States
(12) Patent Application Publication
(10) Pub. No.: US 2026/0278144 A1
(43) Pub. Date: Sep. 17, 2026

(54) PRIVACY-PRESERVING RESILIENT QUERY PROCESSING

(71) Applicant: Microsoft Technology Licensing, LLC, Redmond, WA (US)

(72) Inventors: Lisa Viola Viktoria JONSSON, Troms (NO); Jan-Ove Almli KARLBERG, Troms Og Finnmark (NO); Tor KREUTZER, Troms (NO)

(21) Appl. No.: 19/079,067

(22) Filed: Mar. 13, 2025

(51) Int. Cl. G06F 21/62

(52) U.S. Cl. CPC G06F 21/6227; G06F 21/6254

(57) ABSTRACT

In various examples, a distributed query engine utilizes a negative cache to detect queries that are likely to fail or otherwise cause an error in execution and returns exceptions. For example, input queries are anonymized by replacing sensitive information with placeholders, and a mapping table is generated to enable the sensitive information to be restored in the exception messages. Continuing this example, a block ratio is used to allow a certain percentage of queries included in the negative cache to be executed, and for compilation and/or execution information to be generated. In some embodiments, this compilation and/or execution information is used to determine whether to update the negative cache—for example, by adding queries to the negative cache.

### BACKGROUND

Typically, federated and/or distributed storage systems are designed to manage and integrate data across multiple, often disparate, storage systems and databases. These systems provide a unified interface for accessing and managing data, regardless of where it is physically stored. This approach is particularly useful in cloud computing environments, where data may be distributed across various locations and platforms. In this manner, users can search and/or query multiple disparate data sources from a single system and/or service. In addition, the federated and/or distributed storage systems can maintain a wide variety of information, and often this information includes sensitive data that users want securely stored and protected from unauthorized access. However, especially in cloud computing environments, this data and/or systems are exposed to potential attackers and other threats.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments described herein are directed to a privacy-preserving negative caching system that reduces consumption of computing resources in distributed systems and prevents various attack vectors and malicious activity. Furthermore, in various embodiments, restoration of sensitive data and other material is performed to provide users with important information in response to failed queries. For example, removing and/or anonymizing private and/or sensitive information during evaluation of queries prevents unauthorized access and preserves data privacy. However, in such examples, anonymized results and/or error messages fail to provide important information to users regarding. Therefore, in various embodiments, this private and/or sensitive information is restored to preserve meaningful error information that maintains the accuracy and relevance of the operation.

In various embodiments, an input (query, search, or other operation) is parsed to generate an abstract syntax tree (AST), the AST is then anonymized to remove sensitive and/or private information. For example, sensitive and/or private information such as variable names and constant values are replaced with anonymized values, and a mapping of the anonymized values to the variable names and constant values is generated. In an embodiment, a cache key is generated based on the anonymized AST (for instance a query pattern or other information identifying the input) and checked against a negative cache to determine if the cache key exists in the negative cache. In one example, if the cache key exists in the negative cache, an exception and/or error is generated. However, in another example, if the cache key does not exist in the negative cache, the input (for instance the AST of the query) is compiled and evaluated.

In various embodiments, if the evaluation fails, an evaluation error assessor determines whether to record the failure in the negative cache. For example, not recording the cache key in the negative cache prevents errors that are transient and/or unlikely to occur again from blocking execution of various inputs. Furthermore, in some embodiments, to further prevent false positives, a block ratio is used to allow some inputs to be processed based on a type of error and/or metadata associated with the error and/or input. Returning to the example above, despite the cache key existing in the negative cache, the input, for a certain percentage and/or ratio of inputs, is still processed. In one example, deterministic errors are blocked; however, transient errors are allowed for a certain percentage of inputs. In this manner, a fraction of queries are not blocked to avoid false positives and gather telemetry. Finally, in various embodiments, a secure restore is performed to reconstruct exception messages with the sensitive and/or private information remoted from the input. For example, a function is used to generate the exception message, based on the mapping created during anonymization to restore variable names and/or constants.

### BRIEF DESCRIPTION OF THE DRAWINGS

The present disclosure is described in detail below with reference to the attached drawing figures, wherein:

FIG. 1 depicts an environment in which one or more embodiments of the present disclosure can be practiced.

FIG. 2 depicts an environment in which a distributed query engine utilizes a negative cache during processing of queries, in accordance with at least one embodiment.

FIG. 3A depicts an example function that encodes an exception message, in accordance with at least one embodiment.

FIG. 3B depicts an example function that encodes an exception message, in accordance with at least one embodiment.

FIG. 3C depicts an example of a secure restore function that encodes an exception message, in accordance with at least one embodiment.

FIG. 4 depicts an example process flow for processing queries in a distributed system using a negative cache, in accordance with at least one embodiment.

FIG. 5 is a block diagram of an exemplary computing environment suitable for use in implementations of the present disclosure.

FIG. 6 is a block diagram of an example computing environment in which embodiments described herein may be employed.

FIG. 7 is a block diagram of a Large Language Model that uses particular inputs to make particular predictions, according to some embodiments.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, such as to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-useable instructions stored on computer storage media. The methods may be provided by a stand-alone application, a service or hosted service (stand-alone or in combination with another hosted service), or a plug-in to another product, to name a few.

Aspects of the present disclosure relate to technology for improving electronic communication technology and enhanced computing services for a user, based on a privacy-preserving caching system that is capable of restoring sensitive and/or private information, addressing significant limitations in existing systems. Traditional distributed data storage systems often struggle with unpredictable queries and human adversaries. For example, malicious actors can utilize various attack vectors, such as the variability of query constants, to perform various malicious operations such as potential denial-of-service (DoS) attacks. In addition, there are various privacy concerns with distributed data storage systems due to access to sensitive information and the possibility of exposure. For example, queries or other inputs can cause exposure of sensitive information. Aspects of the technology described herein provide a number of improvements over existing technologies. For instance, in various embodiments, a distributed query engine provides a negative cache that is used to detect query patterns and/or other inputs that result in errors or otherwise fails and returns exceptions without the need to evaluate and/or execute inputs (for instance queries), thereby enhancing system resilience and privacy.

In various embodiments, the distributed query engine includes a negative cache that stores query patterns that have failed during compilation and/or evaluation. In one example, in response to obtaining an input to a distributed storage system, the input is compared to the negative cache and, in response to a determination that the input is included in the negative cache (for instance a cache hit), an exception or other error message is returned in response to the input without processing the input, exposing sensitive information, consuming excess computing resources, or risking an attack. In various embodiments, the distributed query engine parses the input to generate an abstract syntax tree (AST). For example, a query is parsed and an AST is generated to represent the query.

In an embodiment, sensitive information within the AST is then anonymized by replacing constants and/or variable names included in the query with unique values that do not include sensitive information. For example, variable names “Jane Doe” and “John Doe” are replaced with “var0” and “var1” based on a pattern or other information. Furthermore, in such embodiments, a mapping between sensitive information included in the query and the substituted data is created to enable restoration of the sensitive information. In an embodiment, the distributed query engine generates a cache key based on the anonymized query pattern (for instance the anonymized AST) and/or metadata corresponding to the input, and the cache key is used to determine whether the input exists in the negative cache.

In one example, in response to obtaining a new query, the distributed query engine determines if the cache key exists in the negative cache. Continuing this example, if the cache key is found (for instance a cache hit) in the negative cache, the distributed query engine generates an exception associated with the query pattern identified in the negative cache. Alternatively, in this example, if the cache key is not found (for instance a cache miss) in the negative cache, the anonymized AST representing the query is compiled and evaluated. In various embodiments, in response to an input (for instance the anonymized AST) failing during compilation and/or evaluation, failure information is recorded in the negative cache for future reference.

In various embodiments, an evaluation error assessor determines based on the failure information and/or other information associated with the input whether to add the query pattern to the negative cache. In one example, if the query failed due to throttling, network error, and/or other transient error, the evaluation error assessor determines not to include the cache key in the negative cache, as the particular error is unlikely to happen again. However, in another example, if the query fails due to a lack of access rights and/or privileges, the evaluation error assessor determines to include the cache key representing the query pattern in the negative cache, as the user executing the query likely does not have access rights to execute the query.

Furthermore, in various embodiments, the evaluation error assessor determines various types of failure and the frequencies associated with the failures. For example, the evaluation error assessor includes a machine learning model such as an Artificial Neural Network (ANN) and/or a Large Language Model (LLM) that distinguishes between transient errors and persistent errors. Furthermore, in various embodiments, the evaluation error assessor uses threshold-based evaluation, stochastic models, and/or error-type analysis to determine whether to add a cache key associated with a particular query pattern to the negative cache.

In an embodiment, to avoid false positives, the distributed query engine performs a block check to enable a fraction of queries included in the negative cache to be compiled and evaluated, allowing the distributed query engine to gather telemetry and improve performance. The block ratio, in various examples, is adjusted based on computing resource usage, query success rates, false-positive rates, and/or other information associated with the performance of the distributed query engine.

In various embodiments, the distributed query engine includes a secure restore component to reconstruct exception messages, ensuring that sensitive information that was removed from the input is restored and included in any exception and/or error messages to provide the user with valuable context information associated with the particular failure. For example, user-provided variable names or constants are substituted back into the exception message based on the mapping generated during anonymization of the input.

Advantageously, the embodiments described herein improve upon conventional systems by providing a solution managing query failures, preventing various attack vectors (both intentional and unintentional), and preserving privacy in distributed data storage systems. For example, certain embodiments provide several technical advantages and solutions that address key challenges in distributed data storage systems, including enhanced system resilience: A negative cache mechanism improves system stability by efficiently identifying and handling problematic queries. This approach reduces the computational burden on the system by quickly recognizing and responding to queries that are likely to fail, without needing to fully process them each time. Improved privacy protection: An anonymization process safeguards sensitive information by replacing identifiable data with generic placeholders before query processing. This implementation minimizes the risk of data exposure during query execution and error handling, enhancing overall system security. Efficient query handling: By storing information about failing queries in the negative cache, these embodiments can quickly identify and respond to similar problematic queries in the future. This reuse of information reduces unnecessary processing and improves response times for known issue patterns. Intelligent decision-making: An evaluation error assessor employs a machine learning model to analyze query failures and determine appropriate actions. Embodiments using this intelligent component enable the system to adapt to changing query patterns and error types, improving overall system performance and reliability. Reduced false positives: A block ratio check mechanism allows a controlled percentage of queries flagged by the negative cache to still be processed. This approach helps in gathering ongoing telemetry data and reduces the likelihood of incorrectly blocking valid queries, thereby improving system accuracy. Optimized resource utilization: By quickly identifying and handling problematic queries, certain embodiments can conserve computing resources that would otherwise be wasted on processing queries destined to fail. This optimization leads to more efficient use of system resources and improved overall performance. Adaptive error handling: In some embodiments, the system has functionality to learn from query failures and adjust its behavior, accordingly, thereby providing a more nuanced and effective approach to error management. This adaptability helps in maintaining system reliability even as query patterns and data structures evolve over time. Enhanced security against attacks: In some embodiments, the system has functionality to identify and block potentially harmful query patterns helps prevent various types of attacks, including intentional ones like denial-of-service attempts and unintentional ones that may arise from poorly formed queries. Improved user experience: By quickly identifying problematic queries and providing meaningful error messages (through the secure restore process), some embodiments offer users more timely and helpful feedback, potentially reducing frustration and improving overall user satisfaction. Scalability in distributed environments: A negative caching implementation is particularly beneficial in distributed systems, where it can facilitate managing query loads across multiple nodes more effectively, thereby improving system scalability and performance in large-scale deployments. These technical advantages collectively contribute to a more robust, efficient, and secure distributed query processing system, addressing critical challenges in managing large-scale data storage and retrieval operations.

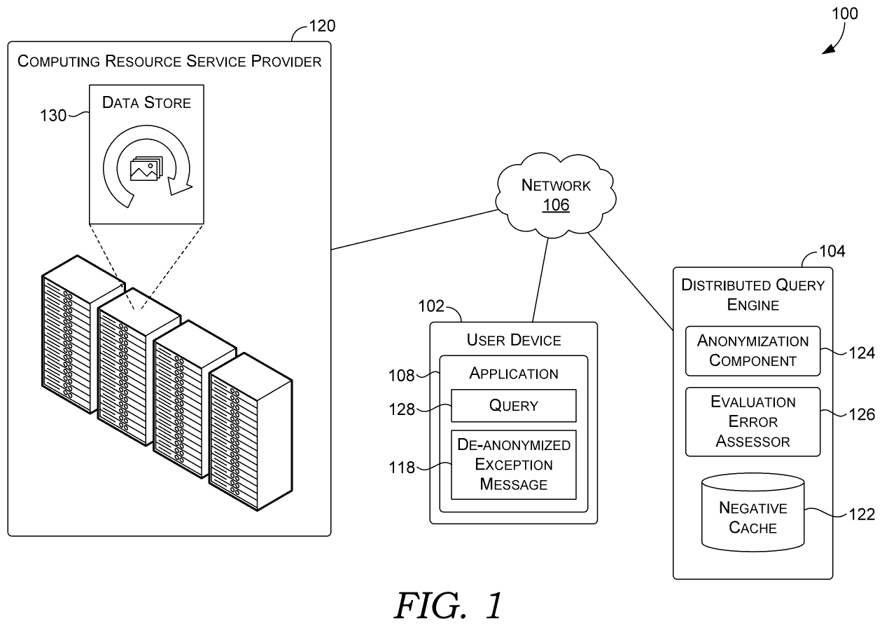

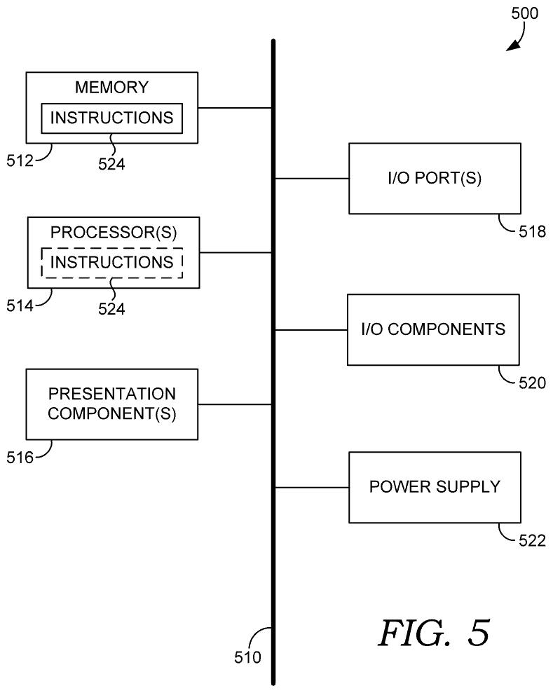

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (for instance machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 5.

It should be understood that operating environment 100 shown in FIG. 1 is an example of one suitable operating environment. Among other components not shown, operating environment 100 includes a computing resource service provider 120, a user device 102, distributed query engine 104, and a network 106. Each of the components shown in FIG. 1 can be implemented via any type of computing device, such as one or more computing devices 500 described in connection with FIG. 5, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

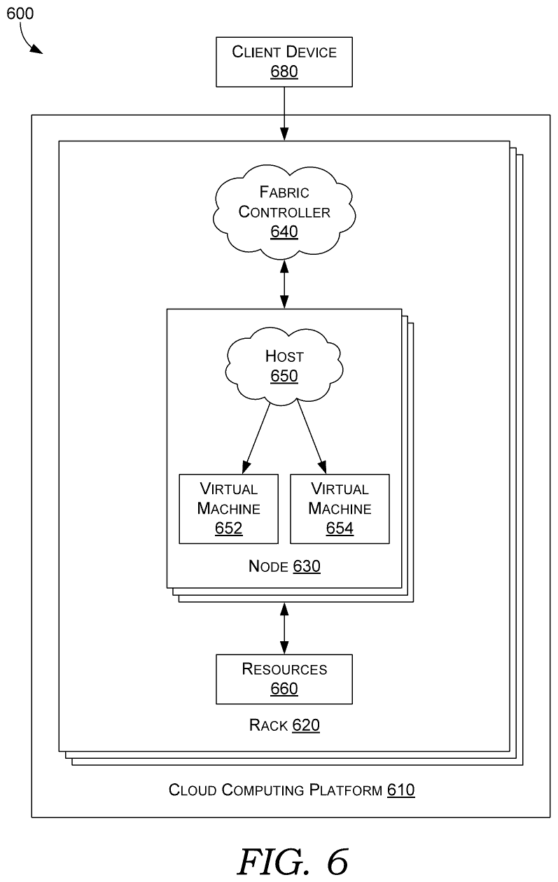

It should be understood that any number of devices, servers, and other components can be employed within operating environment 100 within the scope of the present disclosure. Each can comprise a single device or multiple devices cooperating in a distributed environment. For example, the distributed query engine 104 includes multiple server computer systems cooperating in a distributed environment to perform the operations described in the present disclosure. Further, in some implementations, environment 100 is implemented at least in part in a distributed computing environment such as distributed computing environment 600 (discussed below with respect to FIG. 6) comprising a plurality of such computing devices. For example, the user device 102 can be at least partially supported using computing resources of the computing resource service provider 120.

User device 102 can be any type of computing device capable of being operated by an entity (for instance an individual or an organization) and that obtains data from the distributed query engine 104 and/or a data store 130, which can be facilitated by the distributed query engine 104 (for instance a server operating as a frontend for the data store 130). The user device 102, in various embodiments, provides an input, such as a query, to the distributed query engine 104 using the application 108. For example, the application 108 enables the user to query the data store 130 and obtain results corresponding to various queries. In various embodiments, the computing resource service provider 120, user device 102, and/or distributed query engine 104 allows users to submit structured query language (SQL) queries to access and retrieve data stored across multiple databases and storage systems (for instance the data store 130). In one example, the application 108 provides a user interface, enabling integration and querying of data regardless of its physical location. Furthermore, in various embodiments, data virtualization and metadata management are used to abstract the underlying storage infrastructure, allowing users to perform complex queries and analytics as if the data were in a single data store (for instance the data store 130).

In some implementations, user device 102 is the type of computing device described in connection with FIG. 5. By way of example and not limitation, the user device 102 can be embodied as a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice.

In various embodiments, the application 108 includes any application capable of facilitating the exchange of information between the user device 102 and the distributed query engine 104. For example, the application 108 provides the query 128 to the distributed query engine 104 which determines whether to execute the query or return an exception message, thereby potentially conserving computing resources, preventing attacks, and/or maintaining data privacy. In some implementations, the application 108 comprises a web application, which can run in a web browser, and can be hosted at least partially on the server side of the operating environment 100. In addition, or instead, the application 108 can comprise a dedicated application, such as an application being supported by the user device 102 and computing resource service provider 120. In some cases, the application 108 is integrated into the operating system (for instance as a service). It is therefore contemplated herein that “application” be interpreted broadly.

For cloud-based implementations, for example, the application 108 is utilized to interface with the functionality implemented by the distributed query engine 104. In some embodiments, the components, or portions thereof, of the distributed query engine 104 are implemented on the user device 102 or other systems or devices. Thus, it should be appreciated that the distributed query engine 104, in some embodiments, is provided via multiple devices arranged in a distributed environment that collectively provide the functionality described herein. Additionally, other components not shown can also be included within the distributed environment.

As illustrated in FIG. 1, the distributed query engine 104 includes an anonymization component 124, an evaluation error assessor 126, and a negative cache 122. In various embodiments, in response to the distributed query engine 104 determining that the query 128 will fail, a de-anonymized exception message 118 is returned to the application 108. For example, as described in greater detail below, the anonymization component 124 removes sensitive and/or private information from the query 128. Therefore, in such examples, the sensitive and/or private information is restored to the exception message to provide context information and other useful information to the user.

Furthermore, in various embodiments, the query 128 is generated by an LLM or other machine learning model. For example, the user of the application 108 provides an input to a chat bot, LLM, or other machine learning model asking for data stored in the data store 130, which is obtained using SQL queries. In various embodiments, the distributed query engine 104 obtains the query 128 and determines whether to allow the computing resource service provider 120, data store 130, or other computing resource to process the query 128. In one example, the distributed query engine 104 provides a frontend to the data store 130 and filters or otherwise prevents the processing of queries that will cause a failure.

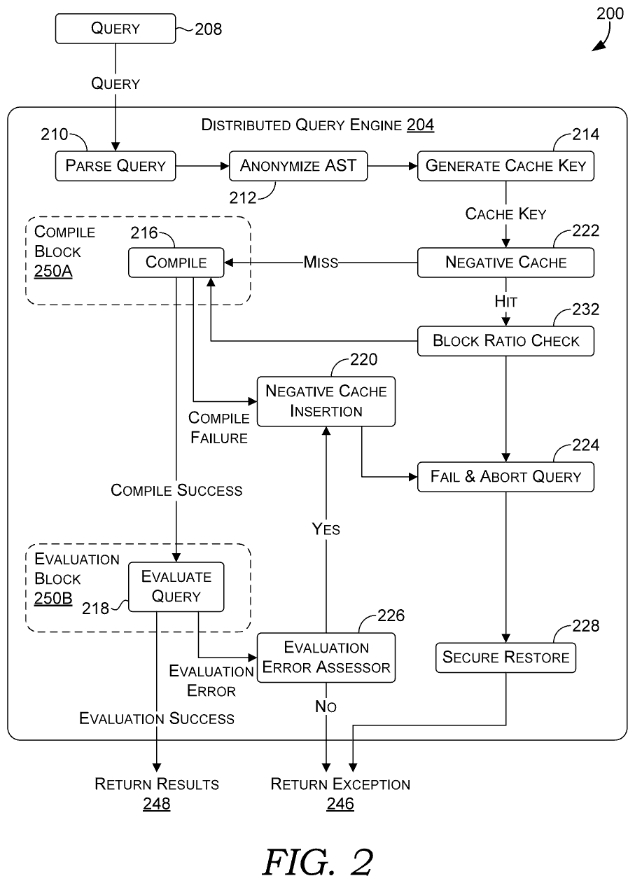

In various embodiments, the anonymization component 124 ensures that sensitive information in the query 128 is replaced with placeholders (for instance non-sensitive data) by creating an anonymized abstract syntax tree (AST) and a mapping table to enable restoration of the sensitive information (for instance during secure restore operations to generate the de-anonymized exception message 118). As described below in connection with FIG. 2, in an embodiment, the distributed query engine 104 parses the query 128 to generate the AST or other representation of the query 128 structure. For example, sensitive information within the AST is identified by traversing the tree to locate constants and variable names. Continuing this example, sensitive information is then replaced with placeholders or other information, such as “?” or other symbols for constants and “varX” for variable names where “X” represents an integer value. In various embodiments, a mapping table is generated to record the original values and their corresponding placeholders. For example, the anonymization component 124 outputs the anonymized AST and the mapping table, ensuring that sensitive information is protected while maintaining the structure of query 128. As described below in connection with FIG. 2, the anonymized AST is then used to compile and evaluate the query 128, and the mapping table is used to generate the de-anonymized exception message 118, in accordance with various embodiments. In yet other embodiments, some values such as predicates are inserted into a query plan executable generated based on the anonymized AST.

In various embodiments, once the anonymized AST is generated, the distributed query engine 104 generates a cache key associated with the query 128 and determines whether the cache key is included in the negative cache 122. In one example, the query 128, metadata associated with the query 128, and/or the anonymized AST is used to generate the cache key. In various embodiments, the anonymized AST or other representation of the query 128 (for instance a query pattern) is hashed using a cryptographic hash function to convert or otherwise generate the cache key. Furthermore, in an embodiment, additional settings and/or parameters (for instance user-specific settings, query execution context, etc.) included in the query 128 or obtained from other sources (for instance the application 108) that influence query execution are included in the hashing process to ensure the cache key accurately reflects the query 128 execution environment. For example, the resulting cache key is a unique identifier for the anonymized query pattern and additional data associated with the query 128, allowing the distributed query engine 104 to efficiently look up and store information corresponding to failed queries without exposing sensitive data such that the cache key is both unique (for instance relative to other queries) and privacy-preserving.

In various embodiments, the cache key is a unique identifier used to store and retrieve negative responses in the negative cache 122. Fox example, if a query fails, causes an exception, or otherwise produces an error, the negative cache 122 stores this result to avoid repeated attempts to execute the same or a similar query. In various embodiments, the cache key is included in the negative cache. In one example, the cache keys are stored as a file and/or metadata. In other examples, the cache key is maintained as a setting and/or configuration. In another example, the cache key is stored as data in a database or in-memory data structure (for instance a hash table) along with the negative response.

In various embodiments, the negative cache 122 stores cache keys corresponding to patterns of queries that have previously failed during compilation or evaluation. As such, in response to obtaining a new query (for instance the query 128), the distributed query engine 104 determines if the cache key exists in the negative cache 122. In one example, if a cache hit occurs, the system retrieves an exception message associated with the query pattern (for instance the query pattern associated with the cache key stored in the negative cache 122). Alternatively, if a cache miss occurs, the query is compiled and evaluated, as described below in FIG. 2. Continuing this example, if the query fails, the anonymized query pattern (for instance the anonymized AST) and/or failure information (for instance error message, exception, stacktrace, and/or other error data) is stored in the negative cache 122 using the generated cache key. In various embodiments, the negative cache 122 enables the distributed query engine 104 to store query patterns associated with queries that compiled but failed during execution, determine when queries matching the stored query patterns are provided, and prevent execution of the queries.

In an embodiment, the evaluation error assessor 126 evaluates query failures to determine whether a query pattern should be added to the negative cache 122. For example, the evaluation error assessor 126 receives the anonymized query pattern (for instance the anonymized AST) and failure information, such as an error type and frequency, and determines whether to insert the query pattern into the negative cache 122 (for instance because the error was transient or deterministic). In various embodiments, the evaluation error assessor 126 uses various techniques and/or combinations thereof to determine whether a query pattern should be inserted into the negative cache 122. In one example, the evaluation error assessor 126 uses a combination of a threshold-based evaluation, stochastic models, and error-type analysis to determine whether a particular query pattern should be inserted into the negative cache 122. In various embodiments, the threshold-based evaluation compares the frequency of failures against various thresholds to identify persistent issues.

In addition, in some embodiments, stochastic models are used to determine the likelihood of failures being transient or persistent. For example, a machine learning model such as an artificial neural network (ANN) can be trained to predict the likelihood of an error associated with a particular query pattern being transient or persistent. In various embodiments, the ANN includes a computational model used to recognize patterns, classify data, and make predictions. In one example, the ANN consists of interconnected nodes, or neurons, organized into layers including input layers that receive data with neurons representing a feature or attribute, hidden layers located between the input and output layers that process the data through weighted connections. Furthermore, in some embodiments, neurons in a hidden layer apply an activation function to the weighted sum of its inputs, introducing non-linearity into the model. Finally, continuing this example, the output layer produces the final predictions, with the number of neurons corresponding to the number of classes or continuous values being predicted.

Furthermore, in various embodiments, during forward propagation, input data is passed through the network layer by layer, with each neuron computing a weighted sum of its inputs, applying an activation function, and passing the result to the next layer. In addition, a loss function that measures the difference between the predicted output and the actual target values can be used to update the model weights—for example, using metrics like mean squared error (MSE) for regression tasks and cross-entropy loss for classification tasks. In various embodiments, backpropagation updates the network weights to minimize the loss function by calculating the gradient of the loss function with respect to each weight and adjusting the weights in the opposite direction of the gradient. For example, an optimization algorithm such as stochastic gradient descent (SGD) is used to update the weights of the machine learning model.

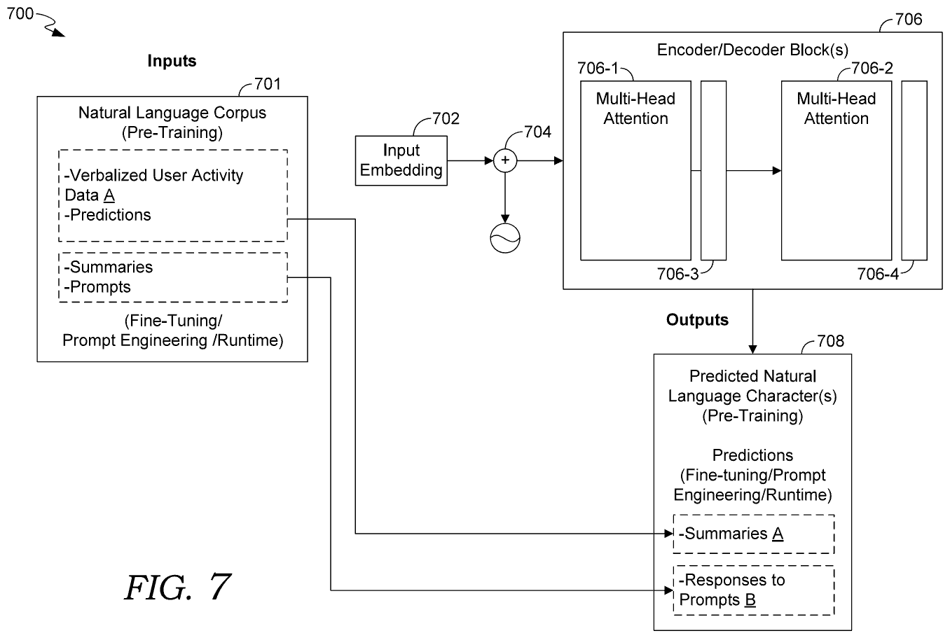

In various embodiments, the inputs to the ANN are features or attributes representing the query, such as the query pattern, AST, query metadata, or other data accessible to the distributed query engine 104. In addition, the output of the ANN can include a classification of a query error as transient or persistent (for instance a probability distribution over classes). Furthermore, other machine learning models such as an LLM, described below in connection with FIG. 7, are trained and used to classify errors and/or determine whether query patterns should be included in the negative cache 122.

In various embodiments, as described below in connection with FIG. 2, a block ratio check is used to avoid false positives determined by the evaluation error assessor 126. For example, the evaluation error assessor 126 determines to include a particular query pattern in the negative cache 122, and the distributed query engine 104 determines, based on the block ratio, to process (for instance compile and evaluate) the query to collect additional context data and/or error data associated with the query pattern.

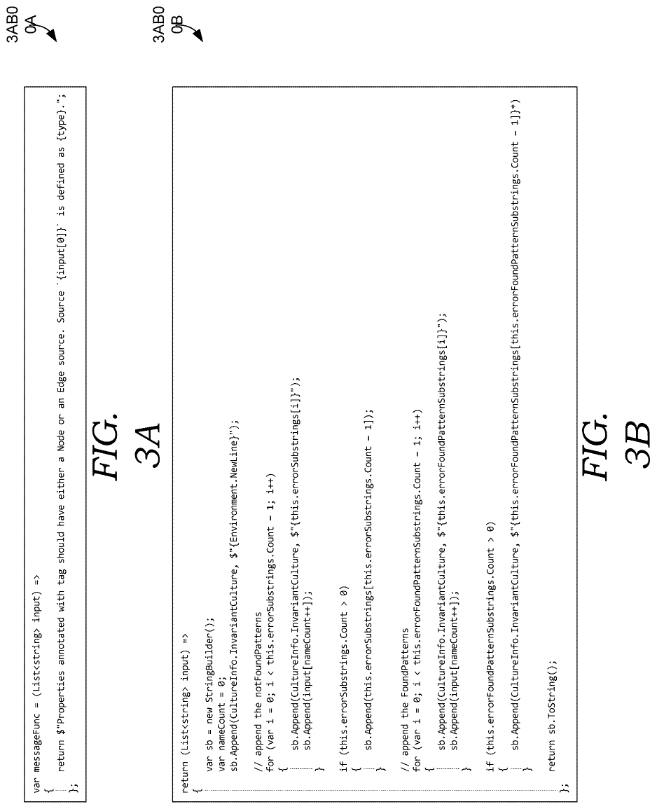

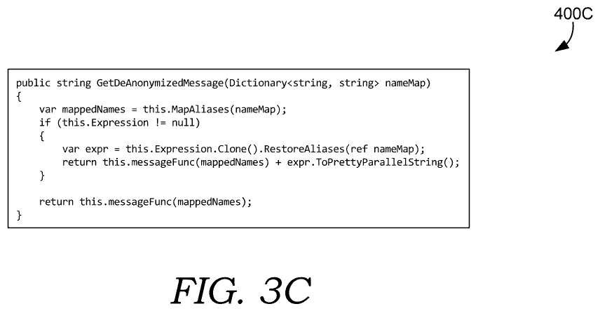

FIG. 2 depicts an environment 200 in which a distributed query engine 204 utilizes a negative cache 222 during the processing of queries, in accordance with at least one embodiment. The distributed query engine 204, in various embodiments, obtains a query 208 and determines whether to return a result 248 of the query 208 or return an exception 246. As described above, in connection with FIG. 1 and/or below in connection with FIG. 3, the distributed query engine 204 includes various components (for instance hardware and/or software) to perform various operations to determine whether to return the result 248 of the query 208 or return the exception 246. For example, the query 208 is obtained from a user (for instance via an application such as application 108 described above) and processed prior to execution to avoid consuming computing resources and/or to mitigate attacks.

In various embodiments, the distributed query engine 204 parses 210 the query 208. For example, an AST is generated based on the query 208. The result of parsing the query 208 is then anonymized, in various embodiments, to generate an anonymized AST 212. In one example, sensitive information is replaced with cache keys that are used to generate a mapping of cache keys that correspond to sensitive information. In various embodiments, specific information included in the AST (for instance constants, variable names, etc.) is replaced with generic information (for instance “var0,” “var1,” etc.) to generate the anonymized AST 212, and a mapping between the specific information and the generic information is generated and stored to enable a secure restore 228 as described below.

In various embodiments, the distributed query engine 204 generates a cache key 214 based on the anonymized AST 212 and/or other information associated with the query 208. For example, a hash function is applied to the anonymized AST 212, and the resulting hash value is used as the cache key 214. In an embodiment, the cache key 214 is checked against the negative cache 222 to determine whether a query pattern associated with the query 208 is stored in the negative cache 222. For example, the negative cache 222 is searched to determine if the negative cache 222 includes the same hash value as the cache key 214. In an embodiment, in response to the cache key 214 being included in the negative cache 222 (for instance a cache hit), the distributed query engine 204 performs a block ratio check 232 to determine whether to fail and abort 224 the query 208.

In various embodiments, the block ratio check 232 causes a fraction and/or portion of queries that include query patterns included in the negative cache 22 to proceed to a compile block 250A and evaluation block 250B to gather telemetry and assess query behavior. For example, a particular block ratio is determined which includes a configurable parameter representing the percentage of queries to be blocked. In various embodiments, the block ratio is different for different query patterns (for instance different types of queries) and/or errors identified in the negative cache 222. For example, a first block ratio is set to 80 percent for a particular query pattern, and 80 percent of incoming queries that match the query pattern as included in the negative cache 222 will be blocked, while the remaining 20 percent will be processed as described below. Continuing this example, a second block ratio is set to 20 percent for a particular error type (for instance a transient error such as throttling errors). Similar to above, the second block ratio causes 20 percent of the queries that match the error type (for instance as indicated by the negative cache) to fail and abort 224 and 80 percent to proceed to the compile block 250A and the evaluation block 250B.

In various embodiments, the block ratio is modified based on an output of the evaluation error assessor and/or a result of executing the query 208. For example, queries allowed by a particular block ratio continue to fail, and the particular block ratio is modified to reduce the number of queries that are allowed to be processed. In various embodiments, the block ratios utilize various throttling mechanisms to adjust the block ratio over time. For example, if queries are associated with a particular query pattern (for instance the cache key), the block ratio is increased until a query associated with the particular query pattern is executed successfully. Continuing this example, in some cases (for instance compilation errors or other deterministic errors) queries associated with the particular query pattern will never execute successfully.

In various embodiments, if the cache key is not included in the negative cache 222 and/or the query 208 is allowed to process, the distributed query engine 204 compiles 216 the query 208. In an embodiment, if the query fails to compile, the cache key 214 is inserted into the negative cache 220, and the query 208 is failed and aborted 224. In other embodiments, if the query compiles successfully, the distributed query engine 204 continues to the evaluation block 250B and evaluates 218 the query 208.

In various embodiments, evaluation 218 of the query 208 executes the query to collect information associated with the query. In other embodiments, the evaluation 218 of the query 208 includes evaluation of a query plan or other information associated with the query 208 and/or generated by compiling the query 208. For example, the query plan (for instance an execution plan) generated during compilation includes steps and/or operations to be performed by a storage system (for instance the data store 130 described above and/or a database management system) to retrieve the requested data. In various embodiments, the query plan includes information about the order of operations, the methods used to access and join tables, the use of indexes, and the estimated cost of various operations. In one example, evaluation 218 of the query 208 includes analyzing the query plan to determine execution of the query 208, potential performance bottlenecks, errors, and/or other results of execution of the query 208.

In one example, a query plan includes a first step to meet access control requirements of a first data source corresponding to a query candidate, a second step to query the first data source, a third step to meet access control requirements of a second data source corresponding to a query candidate, and a fourth step to query the second data source. In an embodiment, the evaluation block 250B comprises computer instructions including rules, conditions, associations, classification models, or other criteria for, among other operations, determining evaluating the query plan. Evaluation of the query plan may take different forms, depending on the particular information items being determined, extracted, and/or processed. For example, evaluation of the query plan comprises a set of rules, such as Boolean logic, various decision trees (for instance random forest, gradient boosted trees, or similar decision algorithms), conditions or other logic, fuzzy logic, neural network, finite-state machine, support vector machine, machine learning techniques, or combinations of these to determine (or facilitate determining) a parallelized query plan according to embodiments described herein.

In an embodiment, if an evaluation error is detected, an evaluation error assessor 226 determines whether to add the cache key 214 to the negative cache 222. In one example, the evaluation error assessor 226 utilizes a combination of threshold-based evaluation, stochastic models, and error-type analysis to make the determination, as described above in connection with FIG. 1. If an evaluation error is not detected, in other embodiments, the query is executed and the results are returned 248. In various embodiments, the evaluation error assessor 226 determines whether the evaluation error is transient or persistent and, if the evaluation error is persistent, causes negative cache insertion 220 to be performed. For example, the cache key 214 is added to the negative cache 222 such that the query pattern associated with the query 208 can be blocked if detected in additional queries.

In various embodiments, the secure restore 228 reconstructs exception messages by at least replacing generic information (for instance placeholders) inserted during anonymization with the sensitive information removed from the query 208. For example, user-provided variable names or constants are treated as plain text rather than executable code and restored based on the mapping generated during anonymization. In various embodiments, the mapping includes a table that contains the original values removed from the query 208 and corresponding placeholders (for instance values inserted into the anonymized AST 212). In an embodiment, the secure restore 228 retrieves the mapping associated with the anonymized AST 212 and constructs the exception message using the placeholders from the anonymized query pattern. For example, the secure restore 228 iterates through the mapping and replaces placeholders in the exception message with the corresponding original value. In an embodiment, to prevent injection attacks, the distributed query engine 204 sanitizes the original values before inserting them into the exception message. In one example, sanitization of the original values includes escaping any special characters or potentially harmful content to ensure that the final message is safe to display.

FIGS. 3A-3C depict example functions 300A-300C that encode an exception message, in accordance with at least one embodiment. In various embodiments, the example functions 300A-300C are executed during secure restore to generate exception messages such as the de-anonymized exception message 118 of FIG. 1. For example, the exception message, instead of being a string or other value returned to a user, includes a function that generates an exception message based on input variables and constants. In an embodiment, the example function 300A and 300B use a mapping of variables and constants replaced in a query (for instance generated during anonymization of the query) to generate the exception message. As illustrated in the example function 300C, variable names and constants are restored using the map and inputted into a particular exception message.

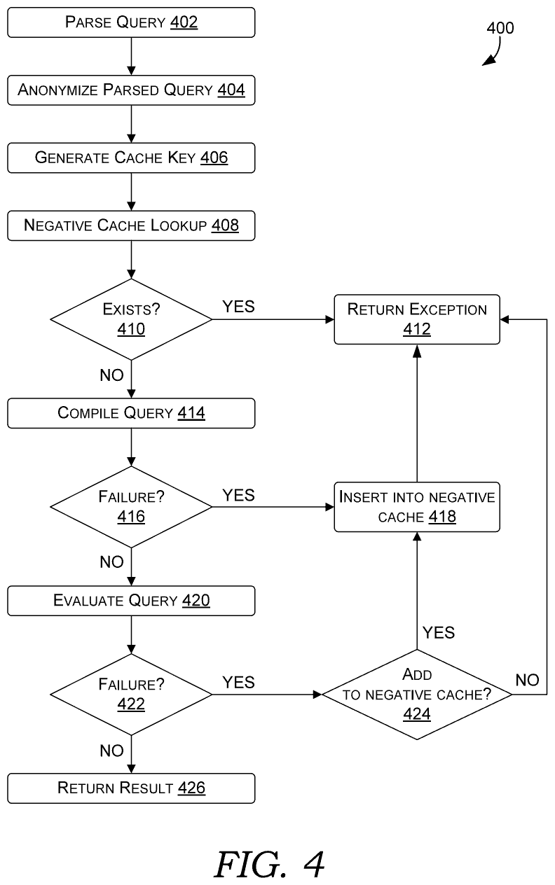

FIG. 4 is a flow diagram showing a method 400 for processing queries in a distributed system using a negative cache in accordance with at least one embodiment. The method 400 can be performed, for instance, by the distributed query engine 104 of FIG. 1. Each block of the method 400 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a stand-alone application, a service or hosted service (stand-alone or in combination with another hosted service), or a plug-in to another product, to name a few.

As shown at block 402, the system implementing the method 400 parses a query. As described above in connection with FIG. 1, in various embodiments, an application operated by a user provides a query to obtain data or other results from a data store. In such embodiments, in order to process the query, the query is parsed to generate a representation of the query. For example, an AST is generated based on the query.

At block 404, the system implementing the method 400 anonymizes the parsed query. For example, constants and/or variables included in the AST are replaced with values that do not include sensitive information such as “con1” and “con2” for constants and “var1” and “var2” for variables. Furthermore, in various embodiments, a mapping of sensitive information to generic information is generated during anonymization. For example, key-value pairs are generated and stored in a table or other data structure. Returning to the example above, the variable “user.id123” is mapped to the key “var1,” enabling the generic information “var1” to be replaced in an exception message with the sensitive information “user.id123.”

At block 406, the system implementing the method 400 generates a cache key based on the anonymized AST. For example, a hash of the anonymized AST is calculated. At block 408, the system implementing the method 400 uses the cache key to perform a lookup operation on the negative cache. As described above, the negative cache, in various embodiments, contains a set of hash values generated by applying a hash function to various query patterns (for instance information associated with a query such as anonymized AST, settings, metadata, or other information associated with queries). The cache key, in one example, is compared to the value included in the negative cache to determine if the cache key exists in the negative cache (for instance a cache hit).

At block 410, the system implementing the method 400 determines if the cache key exists in the negative cache. If the cache key exists in the negative cache (for instance cache hit), the system implementing the method 400 continues to block 412 and returns an exception. In one example, the query matches a query pattern associated with a previously failed query which was recorded in the negative cache and, as a result, the system implementing the method 400 returns an exception message. In various embodiments, the exception message is generated by restoring the sensitive data using a function such as described above in connection with FIGS. 3A-3C.

Returning to block 410, if the cache key does not exists in the negative cache (for instance cache miss), the system implementing the method 400 continues to block 414 and compiles the query. At block 416, the system implementing the method 400 determines if the query fails to compile. For example, the query includes a syntax error or other error that prevents compilation. If the query fails to compile, the system implementing the method 400 continues to block 418 and inserts the cache key into the negative cache. In various embodiments, once the cache key is inserted into the negative cache, the system implementing the method 400 returns to block 412 and returns the exception. However, if the query compiles, the system implementing the method 400 continues to block 420 and evaluates the query. For example, a query plan associated with the query is evaluated to determine whether the query will produce an error. In other example, the query is executed and a result and/or error is obtained.

At block 422, the system implementing the method 400 determines if evaluation of the query failed. If evaluation succeeds, the system implementing the method 400 continues to block 426 and returns the result of the query. However, if evaluation fails, the system implementing the method 400 continues to block 424 and determines whether to add the cache key to the negative cache. For example, if the system implementing the method 400 determines that the evaluation error is transient (for instance throttling error), then the cache key is not inserted into the negative cache and the system implementing the method 400 continues to block 412. In another example, if the system implementing the method 400 determines that the evaluation error is persistent, the cache key is inserted into the negative cache, and the system implementing the method 400 continues to block 418.

Having described embodiments of the present disclosure, FIG. 5 provides an example of a computing device in which embodiments of the present disclosure may be employed. Computing device 500 includes a bus 510 that directly or indirectly couples the following devices: memory 512, one or more processors 514, one or more presentation components 516, input/output (I/O) ports 518, input/output components 520, and illustrative power supply 522. Bus 510 represents what may be one or more buses (such as an address bus, data bus, or combination thereof). Although the various blocks of FIG. 5 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 5 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 5 and make reference to “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 500. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 512 includes computer storage media in the form of volatile and/or nonvolatile memory. As depicted, memory 512 includes instructions 524. Instructions 524, when executed by processor(s) 514, are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 500 includes one or more processors that read data from various entities such as memory 512 or I/O components 520. Presentation component(s) 516 present data indications to a user or other device. Exemplary presentation components include a display device, speaker, printing component, vibrating component, etc.

I/O ports 518 allow computing device 500 to be logically coupled to other devices including I/O components 520, some of which may be built-in. Illustrative components include a microphone, joystick, game pad, satellite dish, scanner, printer, wireless device, etc. I/O components 520 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 500. Computing device 500 may be equipped with depth cameras, such as stereoscopic camera systems, infrared camera systems, camera systems, and combinations of these, for gesture detection and recognition. Additionally, computing device 500 may be equipped with accelerometers or gyroscopes that enable detection of motion. The output of the accelerometers or gyroscopes may be provided to the display of computing device 500 to render immersive augmented reality or virtual reality.

Referring now to FIG. 6, FIG. 6 illustrates an example distributed computing environment 600 in which implementations described in the present disclosure may be employed. In particular, FIG. 6 shows a high-level architecture of an example cloud computing platform 610 that can host a virtualization environment. It should be understood that this and other arrangements described herein are set forth only as examples. For example, as described above, many of the elements described herein may be implemented as discrete or distributed components or in conjunction with other components, and in any suitable combination and location. Other arrangements and elements (for instance machines, interfaces, functions, orders, and groupings of functions) can be used in addition to or instead of those shown.

Data centers can support distributed computing environment 600 that includes cloud computing platform 610, rack 620, and node 630 (for instance computing devices, processing units, or blades) in rack 620. The virtualization environment can be implemented with cloud computing platform 610 that runs cloud services across different data centers and geographic regions. Cloud computing platform 610 can implement a fabric controller 640 component for provisioning and managing resource allocation, deployment, upgrade, and management of cloud services. Typically, cloud computing platform 610 acts to store data or run service applications in a distributed manner. Cloud computing platform 610 in a data center can be configured to host and support operation of endpoints of a particular service application. Cloud computing platform 610 may be a public cloud, a private cloud, or a dedicated cloud.

Node 630 can be provisioned with host 650 (for instance operating system or runtime environment) running a defined software stack on node 630. Node 630 can also be configured to perform specialized functionality (for instance compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a tenant infrastructure or tenancy. The terms “service application,” “application,” or “service” are used interchangeably herein and broadly refer to any software, or portions of software, that run on top of, or access storage and compute device locations within, a datacenter.

When more than one separate service application is being supported by nodes 630, nodes 630 may be partitioned into virtual machines (for instance virtual machine 652 and virtual machine 654). Physical machines can also concurrently run separate service applications. The virtual machines or physical machines can be configured as individualized computing environments that are supported by resources 660 (for instance hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 500 described with reference to FIG. 5, for example. Client device 680 can be configured to issue commands to cloud computing platform 610. In some implementations, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include one or more local area networks (LANs) and/or wide area networks (WANs).

FIG. 7 is a block diagram of a Large Language Model 700 (for instance a BERT model or GPT-4 model) that uses particular inputs to make particular predictions (for instance answers to questions), according to some embodiments. In some embodiments, this large language model 700 represents or includes the functionality as described with respect to the evaluation error assessor 126 of FIG. 1. In various embodiments, the language model 700 includes one or more encoders and/or decoder blocks 706 (or any transformer or portion thereof).

First, a natural language corpus (for instance various WIKIPEDIA English words or BooksCorpus) of the inputs 701 are converted into tokens and then feature vectors and embedded into an input embedding 702 to derive meaning of individual natural language words (for example, English semantics) during pre-training. In some embodiments, to understand English language, corpus documents, such as text books, periodicals, blogs, social media feeds, and the like are ingested by the language model 700.

In some embodiments, each word or character in the input(s) 701 is mapped into the input embedding 702 in parallel or at the same time, unlike existing long short-term memory (LSTM) models, for example. The input embedding 702 maps a word to a feature vector representing the word. However, the same word (for example, “apple”) in different sentences may have different meanings (for example, brand versus fruit). This is why a positional encoder 704 can be implemented. A positional encoder 704 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector as follows:

$$P {E}_{( p o s , 2 i )} = sin ( pos / 1000 {0}^{2 i / {d}_{m o d e l}} )$$

$$P {E}_{( p o s , 2 i + 1 )} = cos ( pos / 1000 {0}^{2 i / {d}_{m o d e l}} ) .$$

After passing the input(s) 701 through the input embedding 702 and applying the positional encoder 704, the output is a word embedding feature vector, which encodes positional information or context based on the positional encoder 704. These word embedding feature vectors are then passed to the encoder and/or decoder block(s) 706, where it goes through a multi-head attention layer 706-1 and a feedforward layer 706-2. The multi-head attention layer 706-1 is generally responsible for focusing or processing certain parts of the feature vectors representing specific portions of the input(s) 701 by generating attention vectors. For example, in Question Answering systems, the multi-head attention layer 706-1 determines how relevant the i^{th} word (or particular word in a sentence) is for answering the question or its relevance to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following formula:

$$Z = softmax ( \frac{Q . {K}^{T}}{Dimension of vector Q , K , or V} ) . V$$

For multi-headed attention, there are multiple weight matrices W^{q}, W^{k}, and W^{v} so that there are multiple attention vectors Z for every word. However, a neural network may only expect one attention vector per word. Accordingly, another weighted matrix, W^{z}, is used to make sure the output is still an attention vector per word. In some embodiments, after the layers 706-1 and 706-2, there is some form of normalization (for example, batch normalization and/or layer normalization) performed to smoothen out the loss surface, making it easier to optimize while using larger learning rates.

Layers 706-3 and 706-4 represent residual connection and/or normalization layers where normalization recenters and rescales or normalizes the data across the feature dimensions. The feedforward layer 706-2 is a feedforward neural network that is applied to every one of the attention vectors outputted by the multi-head attention layer 706-1. The feedforward layer 706-2 transforms the attention vectors into a form that can be processed by the next encoder block or that can make a prediction at 708. For example, given that a document includes a first natural language sequence “the due date is . . . ” the encoder/decoder block(s) 706 predicts that the next natural language sequence will be a specific date or particular words based on past documents that include language identical or similar to the first natural language sequence.

In some embodiments, the encoder/decoder block(s) 706 includes pre-training to learn language (pre-training) and make corresponding predictions. In some embodiments, there is no fine-tuning because some embodiments perform prompt engineering, prompt-tuning, or zero-shot learning. “Prompt engineering” refers to a process of designing or using structured input to the model (referred to as a prompt or prompts) to cause a desired response to be generated by the model. In some embodiments, prompt engineering includes creating the best or optimal prompt, or series of prompts, for the desired user task or output. Accordingly, given a first prompt (which may include target content), if the model produces a first output with a high likelihood of not being the correct response, particular embodiments learn, such that a second output (indicative of a high likelihood of being a correct response) is always produced when such a first prompt is provided as input. In this way, at model deployment time, no output is ever produced with a low likelihood of being the correct response if the first prompt (or variation thereof) is provided, thereby increasing the accuracy of the model's generative outputs.

Pre-training is performed to understand language, and fine-tuning is performed to learn a specific task, such as learning an answer to a set of questions (in Question Answering systems). In some embodiments, the encoder/decoder block(s) 706 learns what language and context are for a word in pre-training by training on two unsupervised tasks (MLM and NSP) simultaneously or at the same time. In terms of the inputs and outputs, at pre-training, the natural language corpus of the inputs 701 may be various historical documents, such as text books, journals, or periodicals in order to output the predicted natural language characters in 708 (not make the predictions at runtime or prompt engineering at this point). The encoder/decoder block(s) 706 takes in a sentence, paragraph, or sequence (for example, included in the input[s] 701), with random words being replaced with masks. The goal is to output the value or meaning of the masked tokens. For example, if a line reads, “please [MASK] this document promptly,” the prediction for the “mask” value is “send.” This helps the encoder/decoder block(s) 706 understand the bidirectional context in a sentence, paragraph, or line at a document. In the case of NSP, the encoder/decoder block(s) 706 takes, as input, two or more elements, such as sentences, lines, or paragraphs, and determines, for example, if a second sentence in a document actually follows (for example, is directly below) a first sentence in the document. This helps the encoder/decoder block(s) 706 understand the context across all the elements of a document, not just within a single element. Using both of these together, the encoder/decoder block(s) 706 derives a good understanding of natural language.

In some embodiments, during pre-training, the input to the encoder/decoder block(s) 706 is a set (for example, 2) of masked sentences (sentences for which there are one or more masks), which could alternatively be partial strings or paragraphs. In some embodiments, each word is represented as a token, and some of the tokens are masked. Each token is then converted into a word embedding (for example, 702). At the output side is the binary output for the next sentence prediction. For example, this component may output 1, for example, if masked sentence 2 follows (for example, is directly beneath) masked sentence 1. The output is word feature vectors that correspond to the outputs for the machine learning model functionality. Thus, the number of word feature vectors that are input is the same number of word feature vectors that are output.

In some embodiments, the initial embedding (for example, the input embedding 702) is constructed from three vectors: the token embeddings, the segment or context question embeddings, and the position embeddings. In some embodiments, the following functionality occurs in the pre-training phase. The token embeddings are the pre-trained embeddings. The segment embeddings are the sentence numbers (that include the input[s] 701) that are encoded into a vector (for example, first sentence, second sentence, etc., assuming a top-down and right-to-left approach). The position embeddings are vectors that represent the position of a particular word in such a sentence that can be produced by positional encoder 704. When these three embeddings are added or concatenated together, an embedding vector is generated that is used as input into the encoder/decoder block(s) 706. The segment and position embeddings are used for temporal ordering since all of the vectors are fed into the encoder/decoder block(s) 706 simultaneously, and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, once pre-training is performed, the encoder/decoder block(s) 706 performs prompt engineering or fine-tuning on a variety of QA datasets by converting different QA formats into a unified sequence-to-sequence format. For example, some embodiments perform the QA task by adding a new question answering head or encoder/decoder block, just the way a masked language model head is added (in pre-training) for performing an MLM task, except that the task is a part of prompt engineering or fine-tuning. This includes the encoder/decoder block(s) 706 processing the inputs 701 (i.e., the verbalized user activity data, the predictions, summaries, and/or prompts) in order to make the predictions and confidence scores as indicated in 708. Prompt engineering, in some embodiments, is the process of crafting and optimizing text prompts for language models to achieve desired outputs. In other words, prompt engineering is the process of mapping prompts (for instance a question) to the output (for instance an answer) that it belongs to for training. For example, if a user asks a model to generate a poem about a person fishing on a lake, the expectation is that the model will generate a different poem each time. Users may then label the output or answers from best to worst. Such labels are input to the model to make sure the model is giving more human-like or best answers, while trying to minimize the worst answers (for instance via reinforcement learning). In some embodiments, a “prompt” as described herein includes one or more of: a request (for instance a question or instruction [for instance write a poem]), target content, a command or instruction, and/or more examples (for instance one-shot or two-shot examples).

In an illustrative example, in some embodiments, the predictions of the output 708 may be generative text, classifications, determinations, and other information relative to query error information, such as those described above with FIGS. 1 and 2. Alternative to prompt engineering or fine-tuning, in some embodiments the inputs 701 and outputs 708 represent “runtime” inputs and outputs. Runtime represents a time after which the large language model 700 has been trained (for instance via pre-training and/or fine-tuning and/or prompt engineering), tested, and deployed.

An artificial intelligence (AI) system refers to an artificial intelligence computing environment or architecture that includes the infrastructure and components that support the development, training, and deployment of artificial intelligence models. It provides necessary hardware, software, and frameworks for developers to create and run artificial intelligence applications. An artificial intelligence system may be a cloud-based AI solution that leverages cloud computing infrastructure to develop, train, deploy, and manage AI models and applications. AI models may specifically refer to generative AI models that are designed to generate new data or content that is similar to, or in some cases entirely different from, data they are trained on.

Artificial intelligence systems can include transformer models that are capable of running complex neural language processing tasks. Transformer models—also known as Large Language Models (LLMs)—have applications in a wide range of industries. An LLM is a trained deep learning model that can recognize, summarize, translate, predict, and generate content using very large datasets. LLMs and other types of generative AI models are associated with a training phase—where a model is taught to learn patterns, relationships, and knowledge from training datasets- and an inference phase, which includes making predictions, classifications, or generating outputs for real-world tasks or queries.

Unlike convolution neural networks (CNNs), which are typically used for image tasks and mostly rely on convolution operations, transformer models are based on simple general matrix multiplication (GEMM) tasks, which can be further broken down to perform a dot product operation on two vectors. While CNN architectures are typically computationally heavy with a relatively small number of parameters, the architecture of transformer models results in the opposite: a very large number of parameters, with a fairly small number of operations. The LLM architecture can create challenges in that performance bottlenecks reside in the memory throughput and capacity rather than the compute engine.

Transformer models operate with memory accesses to retrieve a matrix of weights out of memory, together with a vector (either the input vector or partial result from a previous stage of the model), and multiplying the two. This is true for the model's attention sublayers, the FFN (feedforward network), sublayers, and for the final embedding layer. As vector-matrix multiplication is actually comprised of numerous vector-vector multiplications (dot product), it is fair to say that most memory accesses are used to read two vectors in order to perform a dot product on them. As such, reading out the full vectors is inefficient.

As such, transformer models (also referred to herein as “generative AI models”) require computational resources including processors and memory for the training phase and inference phase. The generative AI models operate with different types of processors (for instance central processing units [CPUs] or graphics processing unit [GPUs]) in architectures that include multi-core CPUs or parallel processors including GPUs and tensor processing units (TPUs). Memory can be used to store model parameters and intermediate data for the training phase and the inference phase. Memory requirements may depend on the size and the architecture of the generative AI models. By way of illustration, an LLM can support an inferencing phase that includes using a trained model to make predictions, draw conclusions, or generate output based on input data or patterns learned during the model's training phase. During the inference phase, an LLM can use DRAM (Dynamic Random-Access Memory) to store various components and data for making inferences. LLMs can store their pre-trained model parameters (for instance weights and biases of the neural network layers) in DRAM, and when a new input is provided for inference, the model accesses these parameters from DRAM to make predictions.

The inference phase can be divided into two stages: a prompt stage and an auto-regressive stage. The prompt stage can include receiving and processing input as a batch of new tokens as part of the same inference. The prompt stage may operate based on a Key-Value (KV) cache technique, where a KV cache is created for tokens in a batch. During the prompt stage, the input is being digested. The auto-regressive state can include using the model to generate the tokens one by one, based on previous tokens, relying on reading the KV cache of previously processed tokens, and adding the data of only the new tokens to the KV cache. This auto-regressive stage includes the model generating a response to the input from the prompt stage.

### OTHER EMBODIMENTS

The following embodiments represent example literal support clauses and embodiments of concepts contemplated herein. Any one of the following embodiments may be combined in a multiple dependent manner to depend from one or more other embodiments. Further, any combination of dependent embodiments (e.g., clauses that explicitly depend from a previous embodiment) may be combined while staying within the scope of aspects contemplated herein. The following embodiments are exemplary in nature and are not limiting.

In some embodiments, a method comprising obtaining, at a distributed query engine, a query that as a result of being processed obtains a result from a distributed data storage system, parsing the query to generate an abstract syntax tree (AST) that includes a set of variables and a set of constraints, anonymizing the AST to generate an anonymized AST by at least replacing the set of variables and the set of constants with a set of values, generating a map of the set of variables and the set of constants to the set of values, where a first variable of the set of variables corresponds to a first value of the set of values, generating a cache key based on the anonymized AST, determining that the cache key is included in a negative cache, and generating an exception message in response to the query by at least restoring the set of variables and the set of constants to the exception message based on the map.

In any combination of the above embodiments of the method, wherein the method further comprises, prior to generating the exception message, determining to compile and evaluate the query based on a block ratio, the block ratio indicating a percentage of queries that are blocked by the negative cache from compilation or evaluation.

In any combination of the above embodiments of the method, wherein the method further comprises causing an evaluation error assessor to determine an error associated with the query that is persistent.

In any combination of the above embodiments of the method, wherein the evaluation error assessor determines that the error associated with the query is persistent based on an error type associated with the error.

In any combination of the above embodiments of the method, wherein the evaluation error assessor determines that the error associated with the query is persistent by at least providing as an input to a machine learning model the error, the anonymized AST, and metadata associated with the query.

In any combination of the above embodiments of the method, wherein the method further comprises modifying the block ratio based on an output of the machine learning model.

In any combination of the above embodiments of the method, wherein generating the cache key further comprises providing as an input to a cryptographic hash function at least one of: the anonymized AST, the query, metadata associated with the query, and a user associated with the query.

In some embodiments, a non-transitory computer-readable medium storing executable instructions embodied thereon, that, when executed by a processing device, cause the processing device to perform operations comprising; obtaining a query at a distributed query engine, generating an anonymized representation of the query by at least: parsing the query to generate a representation of a structure of the query and replacing sensitive information included in the representation with generic information; determining that a cache key associated with the anonymized representation is not included in a negative cache, obtaining an evaluation error based on an evaluation of the query, determining, based on the evaluation error, to include the cache key in the negative cache, and inserting the cache key in the negative cache.

In any combination of the above embodiments of the medium, wherein the evaluation error is generated by at least processing the query to obtain a result.

In any combination of the above embodiments of the medium, wherein determining to include the cache key in the negative cache further comprises providing the evaluation error to a machine learning model.

In any combination of the above embodiments of the medium, wherein the machine learning model is an artificial neural network.

In any combination of the above embodiments of the medium, wherein the operations further comprise causing a second query to fail based on a second cache key generated based on the second query matching the cache key inserted into the negative cache.

In any combination of the above embodiments of the medium, wherein the operation further comprises generating an exception message in response to causing the second query to fail based on a mapping generated based on sensitive information replaced in the second query.

In any combination of the above embodiments of the medium, wherein the operations further comprise causing a second query to be executed based on a block ratio.

In any combination of the above embodiments of the medium, wherein the operations further comprise updating the negative cache based on a result of executing the second query.

In some embodiments, a system comprising: a memory component; and a processing device coupled to the memory component, the processing device to perform operations comprising: generating an anonymized abstract syntax tree (AST) based on an AST generated as a result of parsing a query, the anonymized AST including a first set of values used to replace sensitive information included in the AST, generating a determination to fail the query based on a cache key associated with the anonymized AST being included in a negative cache, and generating an exception message in response to the determination to fail the query, the exception message including the sensitive information based on a mapping of the first set of values to the sensitive information.

In any combination of the above embodiments of the system, wherein the mapping is generated based on the anonymized AST and includes a table indicating values of the first set of values corresponding to the sensitive information.

In any combination of the above embodiments of the system, wherein generating the exception message further comprises executing a function to replace the first set of values with the sensitive information.

In any combination of the above embodiments of the system, wherein generating a determination to fail the query further comprises determining to evaluate the query based on a block ratio indicating a number of queries associated with the cache key to evaluate.

In any combination of the above embodiments of the system, wherein the block ratio is modified based on a result of evaluating the query.

### Additional Structural and Functional Features

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B, and C” means “(A), (B), (C), (A and B), (A and C), (B and C), or (A, B, and C).”

What is claimed is:

1. A method comprising:
obtaining, at a distributed query engine, a query that as a result of being processed obtains a result from a distributed data storage system;
parsing the query to generate an abstract syntax tree (AST) that includes a set of variables and a set of constraints;
anonymizing the AST to generate an anonymized AST by at least replacing the set of variables and the set of constants with a set of values;
generating a map of the set of variables and the set of constants to the set of values, where a first variable of the set of variables corresponds to a first value of the set of values;
generating a cache key based on the anonymized AST;
determining that the cache key is included in a negative cache; and
generating an exception message in response to the query by at least restoring the set of variables and the set of constants to the exception message based on the map.

2. The method of claim 1, wherein the method further comprises, prior to generating the exception message, determining to compile and evaluate the query based on a block ratio, the block ratio indicating a percentage of queries that are blocked by the negative cache from compilation or evaluation.

3. The method of claim 2, wherein the method further comprises causing an evaluation error assessor to determine an error associated with the query that is persistent.

4. The method of claim 3, wherein the evaluation error assessor determines that the error associated with the query is persistent based on an error type associated with the error.

5. The method of claim 4, wherein the evaluation error assessor determines that the error associated with the query is persistent by at least providing as an input to a machine learning model the error, the anonymized AST, and metadata associated with the query.

6. The method of claim 5, wherein the method further comprises modifying the block ratio based on an output of the machine learning model.

7. The method of claim 1, wherein generating the cache key further comprises providing as an input to a cryptographic hash function at least one of: the anonymized AST, the query, metadata associated with the query, and a user associated with the query.

8. A non-transitory computer-readable medium storing executable instructions embodied thereon, that, when executed by a processing device, cause the processing device to perform operations comprising:
obtaining a query at a distributed query engine;
generating an anonymized representation of the query by at least:
parsing the query to generate a representation of a structure of the query; and
replacing sensitive information included in the representation with generic information;
determining that a cache key associated with the anonymized representation is not included in a negative cache;
obtaining an evaluation error based on an evaluation of the query;
determining, based on the evaluation error, to include the cache key in the negative cache; and
inserting the cache key in the negative cache.

9. The medium of claim 8, wherein the evaluation error is generated by at least processing the query to obtain a result.

10. The medium of claim 8, wherein determining to include the cache key in the negative cache further comprises providing the evaluation error to a machine learning model.

11. The medium of claim 10, wherein the machine learning model is an artificial neural network.

12. The medium of claim 8, wherein the operations further comprise causing a second query to fail based on a second cache key generated based on the second query matching the cache key inserted into the negative cache.

13. The medium of claim 12, wherein the operation further comprises generating an exception message in response to causing the second query to fail based on a mapping generated based on sensitive information replaced in the second query.

14. The medium of claim 12, wherein the operations further comprise causing a second query to be executed based on a block ratio.

15. The medium of claim 14, wherein the operations further comprise updating the negative cache based on a result of executing the second query.

16. A system comprising:
a memory component; and
a processing device coupled to the memory component, the processing device to perform operations comprising:
generating an anonymized abstract syntax tree (AST) based on an AST generated as a result of parsing a query, the anonymized AST including a first set of values used to replace sensitive information included in the AST;
generating a determination to fail the query based on a cache key associated with the anonymized AST being included in a negative cache; and
generating an exception message in response to the determination to fail the query, the exception message including the sensitive information based on a mapping of the first set of values to the sensitive information.

17. The system of claim 16, wherein the mapping is generated based on the anonymized AST and includes a table indicating values of the first set of values corresponding to the sensitive information.

18. The system of claim 16, wherein generating the exception message further comprises executing a function to replace the first set of values with the sensitive information.

19. The system of claim 16, wherein generating a determination to fail the query further comprises determining to evaluate the query based on a block ratio indicating a number of queries associated with the cache key to evaluate.

20. The system of claim 19, wherein the block ratio is modified based on a result of evaluating the query.
